(19) United States
(12) Patent Application Publication
(10) Pub. No.: US 2018/0257575 A1
(43) Pub. Date: Sep. 13, 2018

(54) Headrest Hook Hanger Apparatus

(71) Applicants: Roy C. Sanchez, Las Vegas, NV (US); Marnel Estepa, Las Vegas, NV (US)

(72) Inventors: Roy C. Sanchez, Las Vegas, NV (US); Marnel Estepa, Las Vegas, NV (US)

(21) Appl. No.: 15/452,719

(22) Filed: Mar. 7, 2017

(51) Int. Cl. B60R 7/10; B60N 2/48; B60R 7/04

(52) U.S. Cl. CPC B60R 7/10; B60N 2/4876; B60R 7/08; B60R 7/04; B60R 7/043

(57) ABSTRACT

A headrest hook hanger that clamps and mounts to the side of the headrest and over the shoulder of the car seat. The headrest hook hanger has hooks that can hang hats, caps, and garments inside any vehicle.

### BACKGROUND OF THE INVENTION

This invention is reference to U.S. Pat. No. 9,586,529 a headrest hook hanger apparatus that mounts to the side of a headrest invented by Roy Sanchez and Marnel Estepa. The new design is a simple version of the headrest hook hanger apparatus. The differences of the new design versus the previous design is the new design doesn't fold in half and doesn't have a connector that rotates. The simple version has a hook, vertical stand, and base are combine together as a single solid part during manufacturing and the elongated clamp is attach to the base.

### SUMMARY OF THE INVENTION

The headrest hook hanger apparatus can mount on any headrest pole to hang any hats and garments inside any vehicle.

### BRIEF DESCRIPTION OF THE DRAWINGS

FIG. 1 is a diagram of the headrest hook hanger apparatus clamp down to a rod.

FIG. 2 is a diagram displays the swing clamp open and the latch open with the handle unlock.

FIG. 3 is a diagram of the headrest hook hanger apparatus mounted to the side of a headrest pole on a car seat.

FIG. 4 is a exploded view of the headrest hook hanger apparatus and all the parts.

### DETAILED DESCRIPTION OF THE PREFERRED EMBODIMENTS

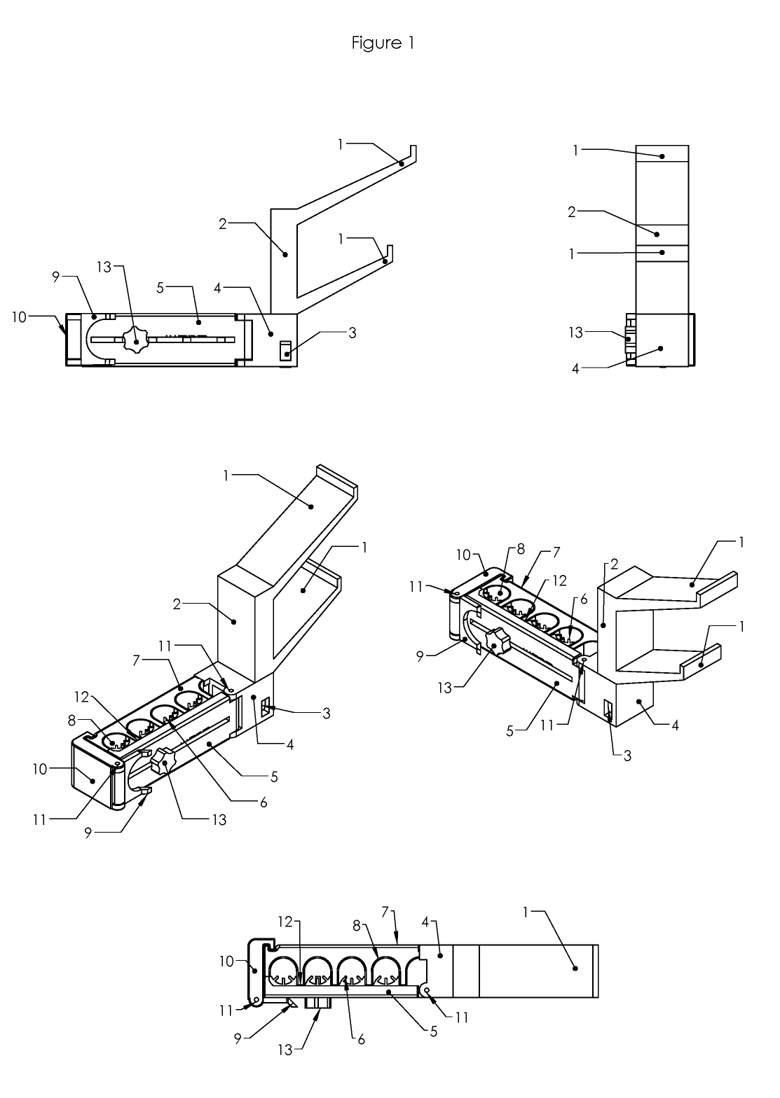

FIG. 1 is a diagram of the headrest hook hanger apparatus; a hook 1 is attach to a stand 2 which sits on top of a base 4. An elongate clamp comprising of a swing clamp 5 is attach to the base 4 with a hinge 11. The opposite side is a stationary clamp 7 attach to the base and a series of hole separator 12 is on the stationary clamp 7. Inside the elongated clamp the hole separator 12 has a rubber insert 8. There is a series of hole separator 12 along the stationary clamp 7 that allows a rod 20 to be position at different length of the elongated clamp. Inside the hole separator 12 are the rubber teeth 6 glued to the swing clamp 5 and rubber insert 8 attach to the stationary clamp 7. A latch 10 clips to the outer stationary clamp 7 and a handle 9 is pulled back to lock down the latch 10. The latch 10 locks the opposite side of the elongated clamp together around the rod 20 to close the headrest hook hanger apparatus. The swing clamp 5 along with the rubber teeth 6 will close together around the rod 20 and rubber teeth 6 and rubber insert 8 squeeze around the rod 20 for a strong grip. The latch 10 is clip onto the outer stationary clamp 7 and the handle 9 is pulled back along the swing clamp 5 provides torque on the latch 10 and locks it down. The elongated clamp is perpendicular to the stand 2 and the hook 1 is on the top outer side of the stand 2.

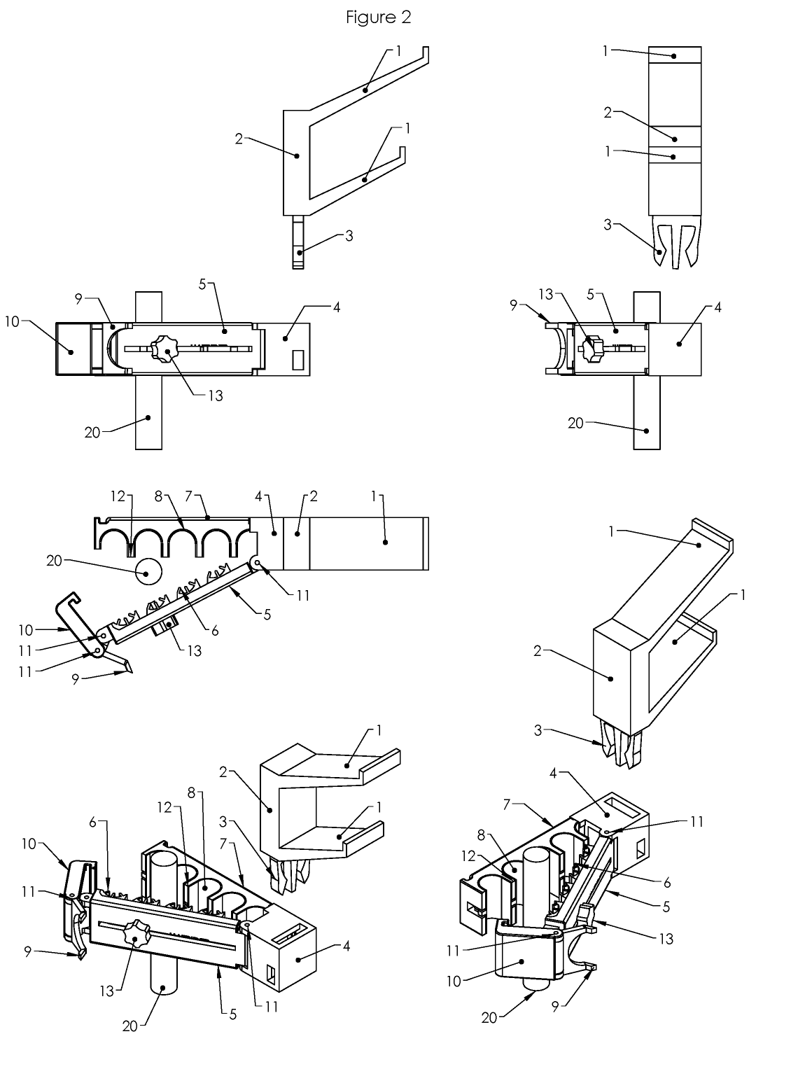

FIG. 2 is a diagram displays the swing clamp 5 opens and with the handle 9 unlock and latch open 10. When the swing clamp 5 is open it can slide the rod 20 into any of the series of hole separator 12 long along the elongated clamp. The rod 20 can be position in any of the holes to adjust the length of the elongated clamp.

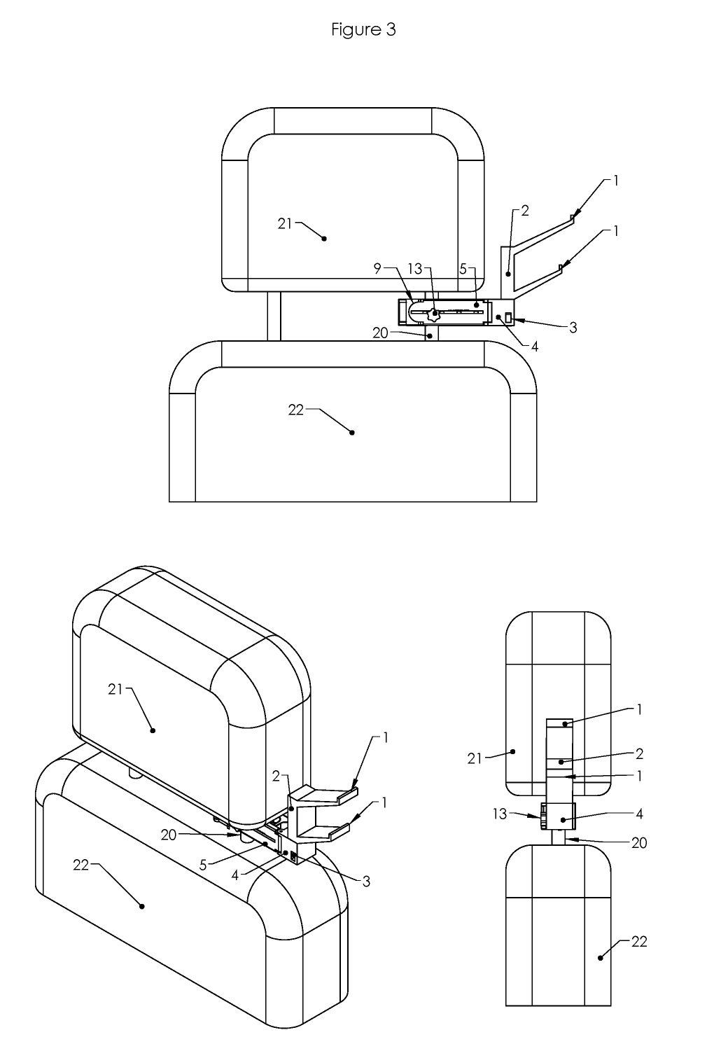

FIG. 3 is a diagram of the headrest hook hanger apparatus where the elongated clamp is clamp around the rod 20 of a headrest 21. The headrest hook hanger apparatus is mounted to the side of the headrest 21 and a dual hook 1 attach to the stand 2 protrudes out on the side of the headrest 21. The base 4 holds the stand 2 and the dual hook 1 while the swing clamp 5 and stationary clamp 7 is wrap around the rod 20 and the handle 9 for the latch 10 is lock to the stationary clamp 7 keeping the elongated clamp together. The elongated clamp is above the shoulder of a seat 22 and the stand 2 is along the side of the headrest 21 and the dual hook 1 on the stand 2 is perpendicular to the elongated clamp to allow any user to hang hats and garments from the side of the headrest 21 and shoulder of the seat 22.

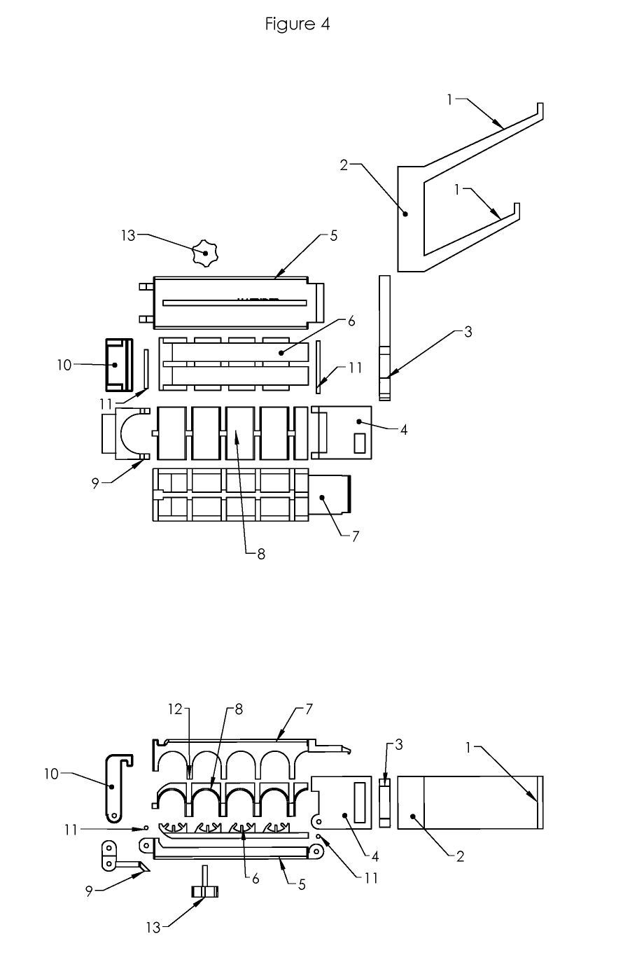

FIG. 4 is an exploded view of the headrest hook hanger apparatus and the parts of which is assembled together. The hook 1 is attach on the top of the stand 2 The stand 2 is attach to the base 4 and the base 4 has a hinge 11 where the the swing clamp 5 connects to the hinge 11. The rubber teeth 6 are glued to the swing clamp 5. The stationary clamp 7 is attach to the base 4. The rubber insert 8 are inside the hole separator 12 along the stationary clamp 7. The end of the swing clamp 5 has a hinge 11 attach is the handle 9 and the latch 10 that locks and unlocks the elongated clamp together.

The headrest hook hanger apparatus can be adapted to use any universal clamp to mount to the headrest and use any different variations of hook design to hang hats, caps, coats, garments inside any vehicle along the side of the headrest and on the shoulder of seat.

1. A headrest hanger apparatus comprising: an elongated clamp having first and second opposite sides; a stand; a hook; a base; wherein the hook is attached to the stand, the stand is attached to the base, the elongated clamp is attached to the base;
wherein the elongated clamp mounts to a rod of a vehicle headrest and the hook allows the user to hang objects thereon;
wherein the elongated clamp further comprises a swing clamp on the first side, a series of rubber teeth, a stationary clamp on the second side, a rubber insert, a latch, wherein the latch locks the first and second opposite sides of the elongated clamp together, and a handle attached to the latch;
wherein the rubber teeth is attached to the swing clamp and the rubber insert is attached to the stationary clamp and a series of hole separator are formed in different positions along a length of the stationary clamp and of the swing clamp to enable the rod to be placed at different positions along the elongated clamp;
wherein the series of rubber teeth are formed within each hole that bite down on the rod when the elongated clamp is closed to provide grip on the rod;
and wherein the swing clamp is attached to the base by a hinge that allows the user to open a mouth between the two sides of the elongated clamp so the rod can be inserted into the holes and the swing clamp and stationary clamp can be closed together and be secured together by the latch;
a hand screw knob is attach on the swing clamp to tighten the grip;
the stand comprising of dual slant hook inserted to a interchangeable and detachable connector.

2. The headrest hanger apparatus of claim 1, wherein the latch and handle are attached at a distal end of the swing clamp, wherein a hinge attach the latch and handle to open and close the swing clamp, wherein the latch clips on to an outer side of stationary clamp and the handle is pulled back to lock down the latch to keep the elongated clamp together around the rod; wherein the latch is one of a solid latch that can grab onto the stationary clamp to lock the rod within the elongated clamp; a hand screw knob on the swing clamp to tighten the hold of the elongated clamp.

3. The headrest hanger apparatus of claim 1, wherein the hook is comprise of dual slant hook and the stand is vertical inserts into the bottom connector , wherein the dual slant hook is on the top side of the vertical stand which is interchangeable and bottom connector fasten to the base.

4. The headrest hanger apparatus of claim 1, wherein the stand and base are detachable and interchangeable together so the stand can stay perpendicular to a floor of the vehicle when the elongated clamp is secured to the rod.

5. The headrest hanger apparatus of claim 4, wherein the elongated clamp comprises: a hinge; and wherein the swing clamp of the elongated clamp is attach to the hinge of the base and the hinge of the base allows the swing clamp to open and close with respect to the base.
